(19) United States
(12) Patent Application Publication
(10) Pub. No.: US 2013/0142159 A1
(43) Pub. Date: Jun. 6, 2013

(54) METHOD FOR TRANSMITTING AND RECEIVING CHANNEL INFORMATION, AND UE AND BASE STATION USING THE SAME

(71) Applicants: Sungkwon Hong, Seoul (KR); Kibum Kwon, Seoul (KR)

(72) Inventors: Sungkwon Hong, Seoul (KR); Kibum Kwon, Seoul (KR)

(73) Assignee: Pantech Co., Ltd., Seoul (KR)

(21) Appl. No.: 13/816,456

(22) PCT Filed: Aug. 12, 2011
(86) PCT No.: PCT/KR11/05958

§ 371 Date: Feb. 11, 2013

(30) Foreign Application Priority Data
Aug. 13, 2010 (KR) 10-2010-0078546

(51) Int. Cl. H04W 72/04

(52) U.S. Cl. CPC H04W 72/042
USPC 370/329

(57) ABSTRACT

Disclosed is a wireless communication system for transmitting and receiving channel information through a carrier aggregation.

### CROSS-REFERENCE TO RELATED APPLICATIONS

This application is the National Stage Entry of International Application No. PCT/KR2011/005958, filed on Aug. 12, 2011, and claims priority from and the benefit of Korean Patent Application No. 10-2010-0078546, filed on Aug. 13, 2010, both of which are hereby incorporated by reference for all purposes in their entirety as if fully set forth herein

### BACKGROUND

1. Field

The present invention relates to a wireless communication system transmitting and receiving channel information through a carrier aggregation.

2. Discussion of the Background

As a bandwidth is extended or a plurality of component carriers are used in a wireless communication system including a user equipment and a base station, an amount of channel information, which should notified to the based station by the user equipment through an UpLink (UL), has been increasing in order to enable the base station to recognize a DownLink (DL) channel state.

Therefore, it is necessary to efficiently transmit the channel information, which should be notified to the base station by the user equipment through the uplink.

### SUMMARY

Additional features of the invention will be set forth in the description which follows, and in part will be apparent from the description, or may be learned by practice of the invention.

In accordance with an aspect of the present invention, there is provided a method of receiving channel information by a base station in a carrier aggregation wireless communication system using one or more downlink component carriers and one or more uplink component carriers, the method including: transmitting control information including an aperiodic channel information request and carrier identification information designating an uplink component carrier reporting the channel information to a user equipment through one of downlink component carriers; and receiving channel information for a downlink component carrier that is linked to the uplink component carrier designated by the carrier identification information from the user equipment through the designated uplink component carrier.

In accordance with another aspect of the present invention, there is provided a method of receiving channel information by a base station in a carrier aggregation wireless communication system using one or more downlink component carriers and one or more uplink component carriers, the method including: transmitting information for a downlink component carrier to a user equipment through a Radio Resource Control (RRC) signaling, wherein channel information for the downlink component carrier is transmitted through an uplink component carrier; transmitting control information including an aperiodic channel information request and carrier identification information designating an uplink component carrier reporting the channel information to a user equipment through one of downlink component carriers; and receiving channel information for a downlink component carrier configured through the RRC signaling from the user equipment through the uplink component carrier.

In accordance with another aspect of the present invention, there is provided a method of receiving channel information by a base station in a carrier aggregation wireless communication system using one or more downlink component carriers and one or more uplink component carriers, the method including: transmitting control information including an aperiodic channel information request and carrier identification information designating an uplink component carrier reporting the channel information to a user equipment through one of downlink component carriers; and receiving channel information for a plurality of downlink component carriers transmitted in series from the user equipment through the uplink component carrier.

In accordance with another aspect of the present invention, there is provided a base station in a carrier aggregation wireless communication system using one or more downlink component carriers and one or more uplink component carriers, the base station including: a control information transmitter for transmitting control information including an aperiodic channel information request and carrier identification information designating an uplink component carrier reporting the channel information to a user equipment through one of downlink component carriers; and a channel information receiver for receiving channel information for a downlink component carrier that is linked to the uplink component carrier designated by the carrier identification information from the user equipment through the designated uplink component carrier.

In accordance with another aspect of the present invention, there is provided a base station in a carrier aggregation wireless communication system using one or more downlink component carriers and one or more uplink component carriers, the base station including: a control information transmitter for transmitting control information including an aperiodic channel information request and carrier identification information designating an uplink component carrier reporting the channel information to a user equipment through one of downlink component carriers; and a channel information receiver for receiving channel information for a downlink component carriers configured through an RRC signaling transmitted to the user equipment from the user equipment through the uplink component carrier.

In accordance with another aspect of the present invention, there is provided a base station in a carrier aggregation wireless communication system using one or more downlink component carriers and one or more uplink component carriers, the base station including: a control information transmitter for transmitting control information including an aperiodic channel information request and carrier identification information designating an uplink component carrier reporting the channel information to a user equipment through one of downlink component carriers; and a channel information receiver for receiving channel information for multiple downlink component carriers transmitted in series from the user equipment through the uplink component carrier.

In accordance with another aspect of the present invention, there is provided a method of transmitting channel information by a user equipment in a carrier aggregation wireless communication system using one or more downlink component carriers and one or more uplink component carriers, the method including: receiving control information including an aperiodic channel information request and carrier identification information designating an uplink component carrier reporting the channel information from a base station through one of downlink component carriers; and transmitting channel information for a downlink component carrier that is linked to the uplink component carrier designated by the carrier identification information to the base station through the designated uplink component carrier.

In accordance with another aspect of the present invention, there is provided a method of transmitting channel information by a user equipment in a carrier aggregation wireless communication system using one or more downlink component carriers and one or more uplink component carriers, the method including: receiving information for a downlink component carrier to a base station through a Radio Resource Control (RRC) signaling, wherein channel information for the downlink component carrier is transmitted through an uplink component carrier; receiving control information including an aperiodic channel information request and carrier identification information designating an uplink component carrier reporting the channel information from a base station through one of downlink component carriers; and transmitting channel information for a downlink component carrier configured through the RRC signaling to the base station through the uplink component carrier.

In accordance with another aspect of the present invention, there is provided a method of transmitting channel information by a user equipment in a carrier aggregation wireless communication system using one or more downlink component carriers and one or more uplink component carriers, the method including: receiving control information including an aperiodic channel information request and carrier identification information designating an uplink component carrier reporting the channel information from a base station through one of downlink component carriers; and transmitting channel information for a plurality of downlink component carriers in series to the base station through the uplink component carrier.

In accordance with another aspect of the present invention, there is provided a user equipment in a carrier aggregation wireless communication system using one or more downlink component carriers and one or more uplink component carriers, the user equipment including: a control information receiver for receiving control information including an aperiodic channel information request and carrier identification information designating an uplink component carrier reporting the channel information from a base station through one of downlink component carriers; and a channel information transmitter for transmitting channel information for a downlink component carrier that is linked to the uplink component carrier designated by the carrier identification information to the base station through the designated uplink component carrier.

In accordance with another aspect of the present invention, there is provided a user equipment in a carrier aggregation wireless communication system using one or more downlink component carriers and one or more uplink component carriers, the user equipment including: a control information receiver for receiving control information including an aperiodic channel information request and carrier identification information designating an uplink component carrier reporting the channel information from a base station through one of downlink component carriers; and a channel information transmitter for transmitting channel information for a downlink component carriers configured through an RRC signaling transmitted from the base station to the base station through the uplink component carrier.

In accordance with another aspect of the present invention, there is provided a user equipment in a carrier aggregation wireless communication system using one or more downlink component carriers and one or more uplink component carriers, the user equipment including: a control information receiver for receiving information including an aperiodic channel information request and carrier identification information designating an uplink component carrier reporting channel information from a base station through one of downlink component carriers; a channel information transmitter for transmitting channel information for multiple downlink component carriers in series to the base station through the uplink component carrier.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a wireless communication system for transmitting channel information according to an embodiment of the present invention;

FIG. 2 illustrates a concept of a scheduling between a carrier aggregation and a carrier in the wireless communication system according to an embodiment of the present invention;

FIG. 3 is a diagram of a base station and a user equipment in the wireless communication system according to an embodiment of the present invention;

FIG. 4 is a diagram of PDCCH transmitting control information of FIG. 3;

FIG. 5 illustrates a concept of the scheduling between a carrier aggregation and a carrier in the wireless communication system according to another embodiment of the present invention;

FIG. 6 and FIG. 7 illustrate concepts of a channel information transmission method for transmitting channel information for one configured downlink component carrier through a PUSCH of one uplink component carrier according to another embodiment of the present invention;

FIG. 8 illustrates a concept of a channel information transmission method for transmitting channel information for all of two or more configured downlink component carriers through a PUSCH of one uplink component carrier according to another embodiment of the present invention; and

FIG. 9 illustrates a concept of a channel information transmission method for transmitting channel information for some of two or more configured downlink component carriers through a PUSCH of one uplink component carrier according to another embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

The present invention has been made in an effort to simplify a control channel and reduce channel information to be transmitted in transmitting the channel information through a carrier aggregation. Further, the present invention has been made in an effort to enable an efficient operation of the control channel in transmitting the channel information for a plurality of carriers.

Accordingly, the present invention has an effect of simplifying the control channel and efficiently transmitting the channel information to be transmitted, in transmitting the channel information through the carrier aggregation.

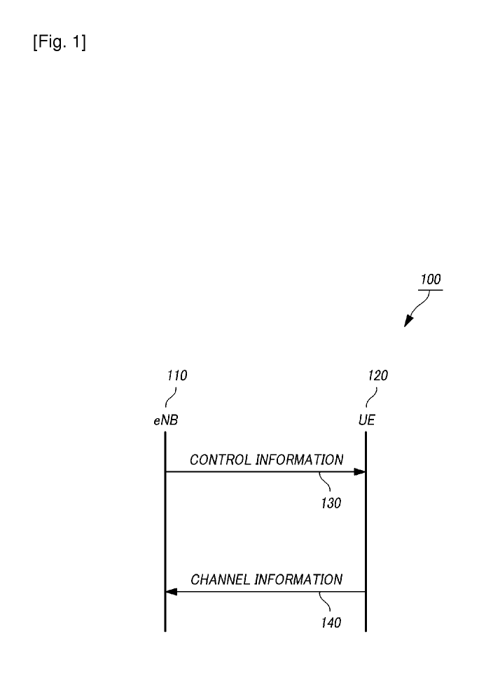

FIG. 1 illustrates a wireless communication system 100 for transmitting channel information according to an embodiment of the present invention.

FIG. 1 is a block diagram schematically illustrating the wireless communication system to which the present invention is applied. In the present invention, the wireless communication system refers to a system for providing various communication services such as voice, packet data, etc.

Referring to FIG. 1, the wireless communication system 100 includes a Base Station (BS) 110 and a User Equipment (UE) 120.

As used herein, the user equipment 120 has an inclusive meaning referring to a user terminal in a wireless communication, and should be construed as a concept including not only a User Equipment (UE) in WCDMA, LTE, High Speed Packet Access (HSPA), etc. but also Mobile Station (MS), User Terminal (UT), Subscriber Station (SS), and wireless device and an Mobile Station (MS) in Global System for Mobile Communication (GSM).

In general, the base station 110 or a cell refers to a station with which the user equipment 120 communicates, and may be referred to by other terms such as a node-B, an evolved Node-B (eNB), a Base Transceiver System (BTS), an access point, and etc.

The user equipment 120 and the base station 110 are used to include comprehensive meanings such as transmission and reception subjects for two links (uplink and downlink) used to implement a technology or a technological idea described in the present invention, and not limited to a specifically designated term or word.

Embodiments of the present invention can be applied to resource allocation in asynchronous wireless communication, which is evolving to the Long Term Evolution (LTE) and the LTE-advanced (LTE-A) through the GSM, the WCDMA, and the HSPA, and resource allocation in synchronous wireless communication, which is evolving to the CDMA, the CDMA-2000, and the UMB. The present invention shall not be restrictively construed based on a particular wireless communication field and shall be construed to include all technical fields to which the concept of the present invention can be applied.

The base station 110 transmits control information 130 to the user equipment 120 through a control channel and the user equipment 120 can receive the control information through the control channel. Meanwhile, the control information 130 may include information related to the channel information. The control channel may be, for example, a Physical Downlink Control Channel (PDCCH) in the Long Term Evolution/Long Term Evolution-Advanced (LTE/LTE-A).

When the control information 130 is information related to the channel information, the user equipment 120 can transmit one or more channel information 140 of one or more component carriers in a carrier aggregation, which will be described later in detail, based on channel information measured for each subband. The base station 110 receives the channel information 140, and can perform a scheduling function selecting the component carriers or allocating the subband of each component carrier.

The aforementioned channel information 140 measured for each subband may, for example, include at least one of a Channel Quality Indicator (hereinafter, referred to as a “CQI”), a Precoding Matrix Indicator (hereinafter, referred to as a “PMI”), a Rank Indicator (hereinafter, referred to as a “RI”), a Signal to Noise Ratio (hereinafter, referred to as an “SNR”), and a Frame Error Rate (FER).

The aforementioned wireless communication system 100 including the base station 110 and the user equipment 120 according to an embodiment of the present invention may be applied to the LTE-A defining a technology for the aggregation of multiple carriers.

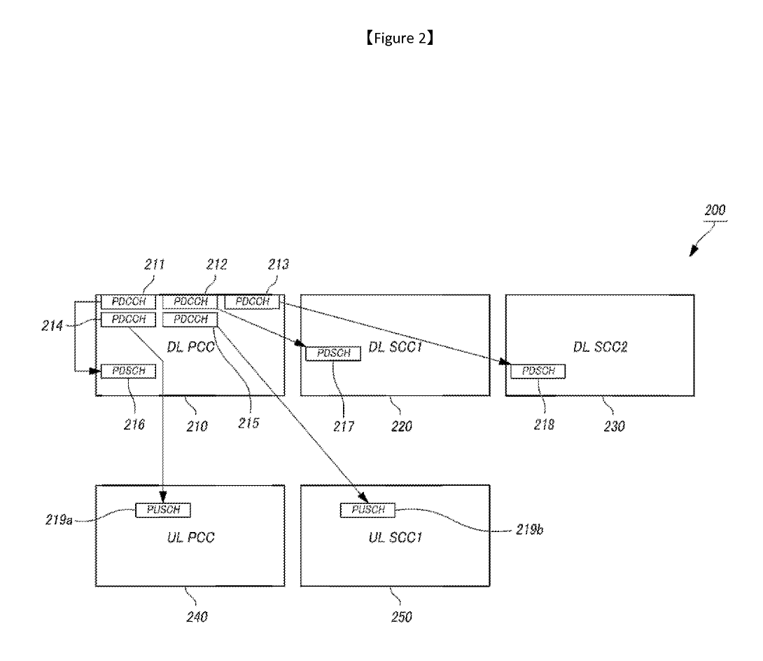

FIG. 2 illustrates a concept of the scheduling between the carrier aggregation and the carrier in the wireless communication system according to an embodiment of the present invention.

The wireless communication system 200 according to an embodiment may use the carrier aggregation having M downlink component carriers for the downlink (M is a natural number selected from 1 to 5), and N uplink component carriers for the uplink (N is a natural number selected from 1 to 5), as shown in FIG. 2. At this time, the component carrier refers to a component carrier included in a plurality of component carriers used in the wireless communication system 200.

For an Frequency Division Duplex (FDD), the carrier aggregation does not allocate and construct one band or one carrier for the downlink and the uplink. Instead, the carrier aggregation combines and constructs a plurality of bands, so it is possible to improve the communication quality and the capacity. Meanwhile, for a Time Division Duplex (TDD), the carrier aggregation follows a method extending the conventional single band or carrier allocated to all uplinks.

In the carrier aggregation, maximally available component carriers for a specific user equipment vary according to each user equipment, and the aggregation of the maximally available component carriers may be differently defined according to each user equipment. The aggregation of the maximally available component carriers may be defined as a configuration component carrier set.

Referring to FIG. 2 again, each of downlink component carriers 210, 220, and 230 include a data channel. Meanwhile, each of the downlink component carriers 210, 220, and 230 may or may not include the control channel. That is, all of the downlink component carriers may include the control channel, or only some of the downlink component carriers may include the control channel.

Each of uplink component carriers 240 and 250 include the data channel. Meanwhile, each of the uplink component carriers 240 and 250 may or may not include the control channel. That is, all of the uplink component carriers 240 and 250 may include the control channel, or only some of the uplink component carriers may include the control channel.

Meanwhile, in the carrier aggregation, a Primary Component Carrier (PCC) and a Secondary Component Carrier (SCC) may exist for the uplink and the downlink. The primary component carrier includes the control channel such as a Physical Uplink Control Channel (PUCCH), to function as a component carrier having a main role in transmitting control information and data in the communication between the base station and the user equipment, and may be configured such that it is specific to the user equipment. Other component carriers except the PCC are defined as the SCC.

Referring to FIG. 2, the number of downlink component carriers 210, 220, and 230 may be, for example, three (M=3), and the number of uplink component carriers 240 and 250 may be two (N=2). The downlink component carrier 210 among the downlink component carriers 210, 220, and 230 corresponds to the downlink PCC, and other downlink component carriers 220 and 230 correspond to the downlink SCC.

Meanwhile, the uplink component carrier 240 among the uplink component carriers 240 and 250 corresponds to the uplink PCC and another uplink component carrier 250 corresponds to the uplink SCC.

The downlink PCC 210 is a single component carrier, but can allocate both of DownLink (DL) grants and UpLink (UL) grants for not only the uplink PCC 240 but also other SCCs 220, 230, and 250 by the scheduling between carriers. The uplink PCC 240 is a single component carrier, but all of Physical Uplink Control Channels (PUCCHs) for the uplink may be (explicitly or implicitly) allocated to the uplink PCC through the proper resource allocation. Here, the term ‘explicitly’ means a case of exactly informing the resource allocation through a higher layer signaling, and the term ‘implicitly’ means a case of informing the resource allocation through a proper rule including a location in a control region of a Physical Downlink Control Channel (PDCCH).

For example, after the control information for the communication between the base station and the user equipment is semi-statically transmitted to the user equipment through the higher layer signaling, the control channel for transmitting dynamic resource allocation information for an allocated shared channel and control information required for the transmission is required. At this time, the control channel corresponds to the PDCCH. The downlink control channel, through which the control information is transmitted, includes a Physical Control Format Indicator Channel (PDFICH) and a Physical Hybrid ARQ Indicator Channel (PHICH) as well as the Physical Downlink Control Channel (PDCCH).

The PDCCH is positioned at a certain part (search space) in a control region in a subframe, and the PDCCH is decoded through a blind decoding from a point of view of the user equipment. The PDCCH is divided into various DCI formats and provides common control information or control information specific to the user equipment. When the control information specific to the user equipment is transmitted, information for decoding the PDSCH or the PUSCH in a point of view of the user equipment and control information required for the communication are provided to the user equipment at the same time.

All DCI formats of the PDCCH for the downlink data transmission are defined as the DownLink grant (DL grant), and all DCI formats of the PDCCH for the uplink data transmission are defined as the UpLink grant (UL grant).

Meanwhile, the control information transmission method in the carrier aggregation is extended to multiple component carriers, and a cross-carrier scheduling, which performs a scheduling from one component carrier to another component carrier, is possible in the method. The cross-carrier scheduling can be performed by adding a Carrier Indicator Field (CIF), which is carrier identification information which will be described later in detail, to a payload of the PDCCH. It is possible to allocate a 3-bit field to the CIF and the CIF can indicate a maximum of 5 component carriers. In the CIF, which is the carrier identification information, only 5 values among available values of 0 to 7 may be practically allocated to the component carriers. Hereinafter, the carrier identification information is referred to as the CIF, but the carrier identification information of the present invention is not limited thereto.

Referring to FIG. 2 again, the downlink PCC 210 may include first to third PDCCHs 211, 212, and 213 including the CIF indicating each of the downlink PCC 210 and the downlink SCCs 220 and 230, and fourth and fifth PDCCHs 214 and 215 including the CIF indicating the uplink PCC 240 and the uplink SCC 250.

Each of the PDCCHs 211 to 215 provides the user equipment with information for decoding a shared channel included in the component carrier indicated by the CIF, for example, first to third PDSCHs 216, 217, and 218, and first and second PUSCHs 219a and 219b, and the control information required for the communication.

When only one transmission band is used, an aperiodic CQI reporting handles only CQI/PMI reporting for the single carrier. However, in a case of the carrier aggregation extending to the multiple component carriers, an extended design is required. A most simple extension method is encoding and reporting the CQI according to an independent mode after a CQI reporting type is determined for each component carrier.

Meanwhile, when a frequency characteristic such as a CM of the uplink is considered, Uplink Control Information (UCI) including channel information of a PUSCH type can be transmitted on the PUSCH of one component carrier. Hereinafter, the UCI and the channel information are understood to have the same meaning, but they may have different meanings according to purposes.

In consideration of the above two cases, the channel information such as the CQI/PMI may be transmitted on one PUSCH, wherein the channel information may be sequentially transmitted with a discrimination between the CQI/PMI according to time (for each subframe). However, such a sequential transmission of the channel information may generate a time delay in the channel information transmission, which may cause a difference between a measured and reported value of the CQI/PMI/RI and a value of the CQI/PMI/RI applied to the real scheduling in the channel information.

Therefore, when the channel information such as the CQI/PMI is reported to the PUSCH of one uplink component carrier in the carrier aggregation, a channel information transmission method, in which a conventional structure is used and the time delay is not generated, is required. Further, in the carrier aggregation, the base station informs the user equipment of the channel information of the downlink component carrier, which will be transmitted, and the uplink component carriers, through which the channel information will be transmitted. The user equipment should transmit the channel information of the downlink component carrier designated from the channel information through the designated uplink component carrier.

So far, the scheduling between the carrier aggregation and the carrier in the wireless communication system is described, but hereinafter, constructions of the base station and the user equipment according to the channel information transmission in the wireless communication system according to an embodiment of the present invention will be described.

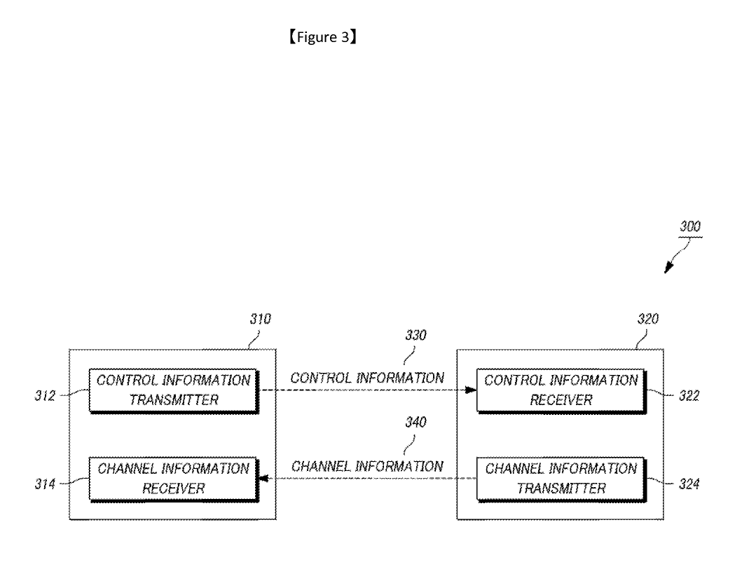

FIG. 3 is a diagram of the base station and the user equipment in the wireless communication system according to an embodiment of the present invention.

Referring to FIG. 3, the wireless communication system 300 according to an embodiment of the present invention includes the base station 310 and the user equipment 320. The base station 310 includes a control information transmitter 312 and a channel information receiver 314. The user equipment 320 includes a control information receiver 322 and a channel information transmitter 324 corresponding to a construction of the base station 310.

The control information transmitter 312 transmits resource allocation information and control information 330 required for the transmission to the user equipment through a control channel. The control information receiver 322 receives the control information 330 from the base station 310 through the control channel. Particularly, the control information transmitter 312 transmits the control information 330, which will be described later, related to the channel information to the user equipment 320 through the control channel.

The channel information transmitter 324 transmits channel information 340, which is measured for each subband, to the base station 310, and the channel information receiver 314 receives the channel information 340. Particularly, the channel information transmitter 324 transmits the channel information 340 to the base station 310 according to the control information received by the control information receiver 322, and the channel information receiver 314 receives the channel information 340.

The control information 330 includes both the control information described above with reference to FIG. 2 and the control information, which will be described later. For example, the control information 330 includes information related to the channel information, which has been described before or will be described later. The downlink control channel, through which the control information 330 is transmitted, includes a Physical Control Format Indicator Channel (PCFICH) and a Physical Hybrid ARQ Indicator Channel (PHICH) other than the Physical Downlink Control Channel (PDCCH). In the following description, the control information transmitter 312 is configured to transmit the control information 330 to the user equipment 320 through the PDCCH, but the control information transmitter 312 of the present invention is not limited thereto.

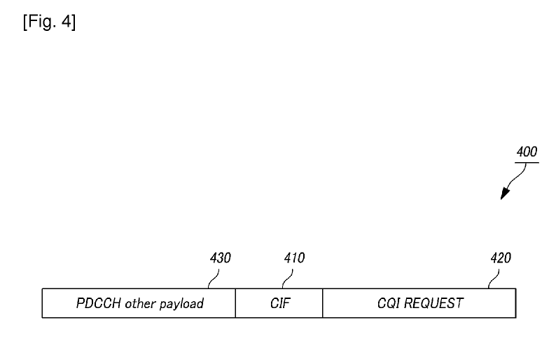

FIG. 4 is a diagram of the PDCCH transmitting the control information of FIG. 3.

As described above, the PDCCH 400, which is one of the control channels transmitting the control information 330, is divided into various DCI formats, and provides the control information specific to the user equipment. When the control information specific to user equipment is transmitted, information for decoding the PDSCH or the PUSCH from a point of view of the user equipment and control information required for the communication are provided to the user equipment at the same time.

Referring to FIG. 4, the PDCCH 400 may include the CIF 410, which is the carrier identification information, a CQI triggering or a CQI request bit 420, and another PDCCH payload 430. At this time, another PDCCH payload 430 refers to control information included in the uplink grant other than the CIF 410 and the CQI triggering bit 420. An order of fields of the CIF 410, the CQI triggering bit 420, and another PDCCH payload 430 is not limited to FIG. 4, and various orders may be applied. For example, the CIF 410 may be positioned at the foremost portion or the backmost portion of the PDCCH.

The scheduling between the carriers, which schedules the carriers from the downlink PCC 210 to another component carrier, can be performed by adding 3-bit CIF 410 indicating a maximum of 5 component carriers to the payload of the PDCCH 400. At this time, 5 values among available values of 0 to 7 included in the 3-bit CIF 410 may be allocated to the component carrier. When the control information 330 is the downlink grant, the CIF 410 added to the control information 330 indicates the downlink component carriers. On the other hand, when the control information 330 is the uplink grant, the CIF 410 added to the control information 330 may indicate the uplink component carriers.

For example, when a DCI format 0 or another format, which is one of the DCI formats of the PDCCH 400, includes the CQI triggering or the CQI request bit 420 aperiodically requesting the Uplink Control Information (UCI) such as the CQI/PMI/RI information for the downlink component carrier and the DCI format 0 or another format is set to “1”, the user equipment transmits the channel information 330 based on the setting. In the specification, the CQI triggering or the CQI request means a message including a request for the CQI, which is one of the channel information, to the user equipment by the base station.

TABLE 1

| CQI triggering bit | Information |
|---|---|
| 1 | Aperiodic CQI request |
| 0 | Not aperiodic CQI request |

Various channel information 340 transmitted to the uplink may include at least one of the Channel Quality Indicator (CQI), the Precoding Matrix Indicator (PMI), the Rank Indicator (RI), the Signal to Noise Ratio (SNR), and the Frame Error Rate (FER) as described above. Hereinafter, the CQI is described as an example of the channel information 340, but the CQI of the present invention is not limited thereto. Although the following description discusses CQI/PMI/RI reporting or the CQI reporting as the channel information, the CQI of the present invention is not limited thereto and may refer to certain control information indicating the channel information.

CQI information is divided into a periodic CQI reporting and an aperiodic CQI reporting.

For example, in the CQI information transmission by the PUCCH, the periodic CQI reporting is used to transmit 4 to 13-bit information with 2/2a/2b format, and the CQI is reported by a proper format according to a type of a band to be reported, a fact whether a MIMO method is used, a degree of the rank, and a CP length of the system.

As described above, the aperiodic CQI/PMI reporting is scheduled on the PUSCH by setting the bit of the aperiodic CQI triggering (or request) to 1 in the uplink grant by the base station. A type of the CQI/PMI/RI reporting (reporting has the same meaning as transmission) is configured by the RRC signaling and constructed in a relation between a downlink transmission mode and an available CQI reporting type.

The aperiodic CQI reporting is transmitted by the PUSCH, to which the uplink resource is allocated by the base station 310, and the CQI information is reported with a discrimination of feedbacks such as a feedback (wideband feedback) for all bands, a feedback (base station construction subband feedback) for a subband constructed by the base station 310, and a subband feedback (user equipment selection subband feedback) set by the user equipment 320. A size of the subband is determined depending on a size of a system band in which the wireless communication system is configured.

At this time, the feedback for all bands (wideband feedback) means that the user equipment 320 reports one wideband CQI value for all system bands. The wideband feedback is an average value of CQI values of the subbands for all the system bands.

The feedback (base station construction subband feedback) for the subband constructed by the base station 310 means that the user equipment reports the difference between one wideband CQI value for all the system bands and the CQI value for each subband. The difference is reported in a 2-bit differential form of the wideband CQI value.

Subband differential CQI offset=subband CQI index wideband CQI index (1)

An available subband differential CQI offset has four values, which are {<=−1, 0, +1, >=+2}.

A size k of the subband for each band is defined in Table 2.

TABLE 2

| System Bandwidth N_{RB}^{DL} | Subband Size (k) |
|---|---|
| 6-7 | NA |
| 8-10 | 4 |
| 11-26 | 4 |
| 27-63 | 6 |
| 64-110 | 8 |

The feedback (user equipment selection subband feedback) set by the user equipment 320 reports CQI values for M selection subbands having a size of k, in a differential form.

Subband differential CQI=(an average index of M selection subbands wideband CQI index) (2)

An available subband differential CQI offset has four values, which are {<=+1, +2, +3, >=+4}.

The selection subbands are indicated by an enumerative source coding to be reported. That is, equation (3) is defined by applying M subband indexes, which are {sₖ}ₖ₌₀^{M-1} subjected to 1≦sk≦N and sk<sk+1, arranged in an ascending order.

$$r = {\sum }_{k = 0}^{M - 1} 〈 \begin{matrix}N - {s}_{k} \\ M - k\end{matrix} 〉 \qquad ( 3 )$$

In equation (3),

$$〈 \begin{matrix}x \\ y\end{matrix} 〉 = \{ \begin{matrix}( \begin{matrix}x \\ y\end{matrix} ) & x \geq y \\ 0 & x < y ,\end{matrix} \\ ( \begin{matrix}x \\ y\end{matrix} )$$

represents xCy, and r has a range of

$$r ∈ \{ 0 , … , ( \begin{matrix}N \\ M\end{matrix} ) - 1 \} .$$

In this event, N refers to the total number of subbands.

The number M of selection subbands and the size k of the subbands are selected in the manner as defined in Table 3.

TABLE 3

| System Bandwidth N_{RB}^{DL} | Subband Size (k) | M |
|---|---|---|
| 6-7 | NA | NA |
| 8-10 | 2 | 1 |
| 11-26 | 2 | 3 |
| 27-63 | 3 | 5 |
| 64-110 | 4 | 6 |

The combinations of the CQI reporting types and the PMI reporting types are divided into modes as shown in Table 4.

TABLE 4

| | | PMI Feedback Type | | |
|---|---|---|---|---|
| | | No PMI | Single PMI | Multiple PMI |
| PUSCH | Wideband | | | Mode 1-2 |
| CQI | (wideband CQI) | | | |
| Feedback | UE Selected | Mode 2-0 | | Mode 2-2 |
| Type | (subband CQI) | | | |
| | Higher | Mode 3-0 | Mode 3-1 | |
| | Layer-configured | | | |
| | (subband CQI) | | | |

A CQI/PMI combination mode available for each transmission mode is defined in Table 5.

TABLE 5

| | Channel Information |
|---|---|
| Transmission mode | Feedback Type |
| 1 | Modes 2-0, 3-0 |
| 2 | Modes 2-0, 3-0 |
| 3 | Modes 2-0, 3-0 |
| 4 | Modes 1-2, 2-2, 3-1 |
| 5 | Mode 3-1 |
| 6 | Modes 1-2, 2-2, 3-1 |
| 7 | Modes 2-0, 3-0 |

In this circumstance, the user equipment 310 transmits information related to the channel information in the control information 330 to the base station 320 in a form of the remaining code point of the CIF 410 included in the uplink grant and the combination of the remaining code point of the CIF 410 and the aperiodic CQI triggering bit 420 in the carrier aggregation shown in FIG. 2

For example, in a 3-bit CIF 410, values of 0 to 4 indicate the component carriers, and values of 5 to 7 may indicate the remaining reserved code points. However, the code point indicating a bit length of the CIF 410 or the component carrier, the remaining code point, or the reserved code point may be changed.

The code point indicating the component carrier represents the number of component carriers, and the number of counted component carriers may have various definitions such as the number of component carriers configured to physically communicate by the user equipment, the number of component carriers configured by the higher layer signaling, and the number of activated component carriers determined by an MAC signaling. The number of reserved code points is changed depending on the definitions.

For example, when the number of counted component carriers is defined as the number of component carriers configured to communicate by the user equipment, the number of component carriers configured to communicate by the user equipment may be 1 to 5, and for example, may be 3. In a case where the number of component carriers is 3, the code points indicating the component carriers are 0 to 2 and the reserved code points may be 3 to 7.

At this time, it is assumed that a value of the CIF 0 is for the PCC, and the rest is for the SCC. Meanwhile, hereinafter, the higher layer signaling may refer to the RRC signaling, which means that information required for the aperiodic CQI/PMI/RI reporting is exchanged suitably for the RRC configuration. However, the higher layer signaling is not limited thereto.

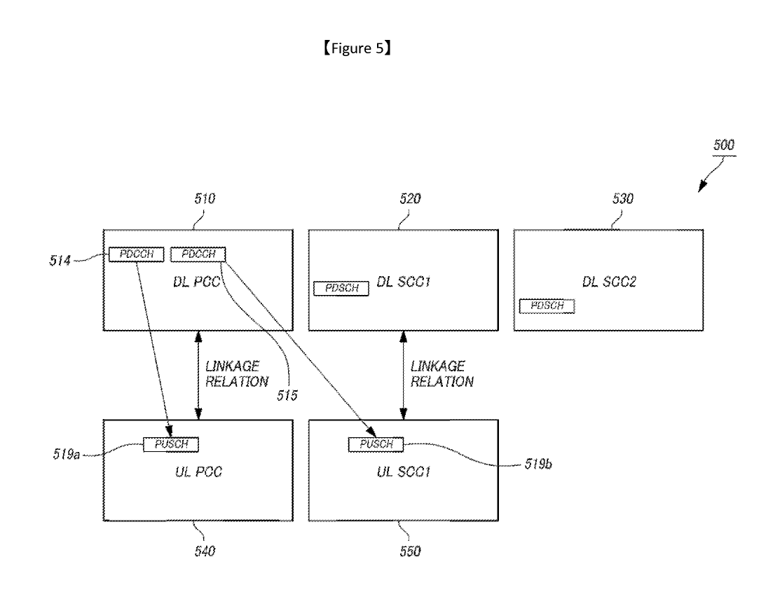

FIG. 5 illustrates a concept of the scheduling between the carrier aggregation and the carrier in the wireless communication system according to another embodiment of the present invention.

Referring to FIG. 5, the wireless communication system 500 uses the carrier aggregation including three downlink component carriers 510, 520, and 530, and two uplink component carriers 540 and 550.

Referring to FIG. 5, the downlink PCC 510 may include first to third PDCCHs (not shown) including the CIF indicating each of the downlink PCC 510 and the downlink SCCs 520 and 530, and fourth and fifth PDCCHs 514 and 515 including the CIF indicating the uplink PCC 540 and the uplink SCC 550, in the control region of the downlink PCC 510, which is identically illustrated in FIG. 2.

The fourth and fifth PDCCHs 514 and 515 including the CIF indicating the uplink PCC 540 and the uplink SCC 550 provide the user equipment with information for decoding first and second PUSCHs 519a and 519b included in the uplink component carrier indicated by the CIF and control information required for the communication at the same time. The fourth and fifth PDCCHs 514 and 515 may be the same as the PDCCH 400 described with reference to FIG. 4, or may not be the same. In the following description, the PDCCH including the fourth and fifth PDCCHs 514 and 515 will be considered the same as the PDCCH 400 shown in FIG. 400, but the PDCCH of the present invention is not limited thereto.

Meanwhile, a linkage relation between the downlink component carrier and the uplink component carrier may be established. The linkage relation may be formed by an RRC signaling. The linkage relation may be notified to the user equipment by a predetermined rule or by implicitly using separate control information.

For example, the downlink PCC 510 and the uplink PCC 540 have the linkage relation therebetween, and the first downlink SCC 520 and the uplink SCC 550 have the linkage relation therebetween. It is possible to designate the component carrier, to which channel information should be reported, by using the linkage relation.

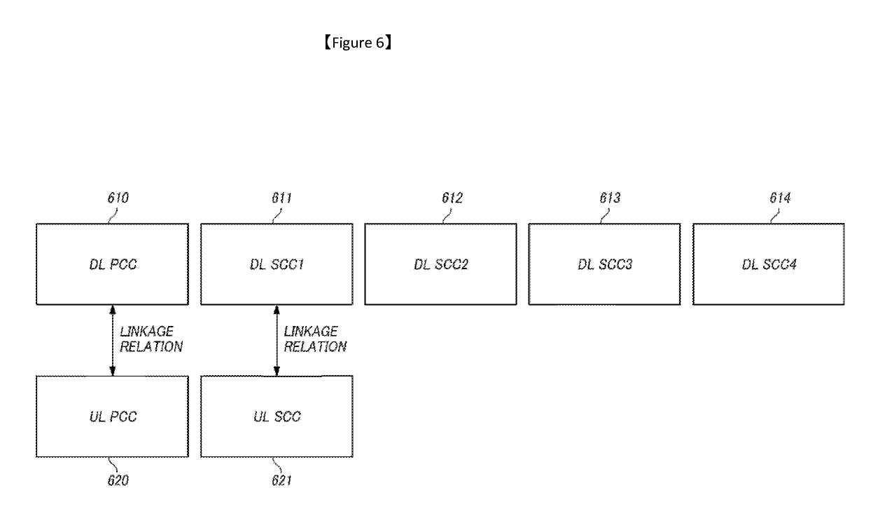

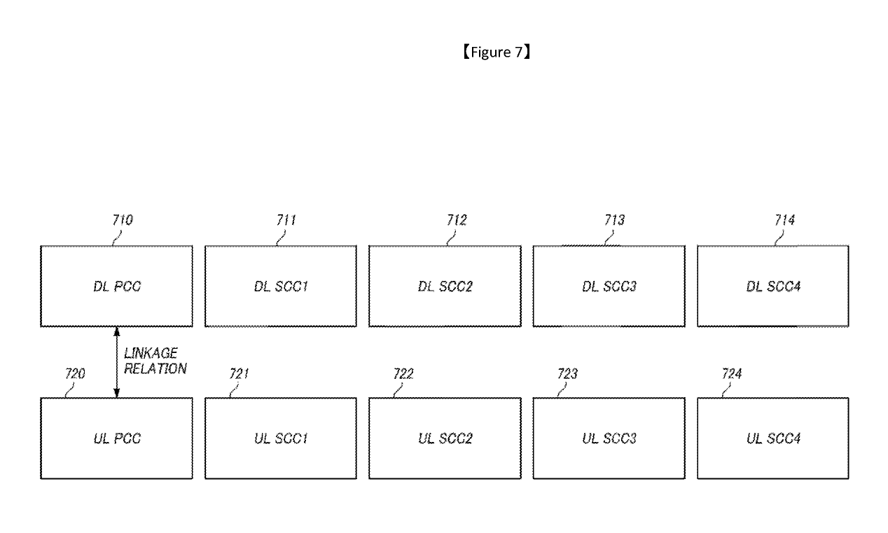

FIG. 6 and FIG. 7 illustrate concepts of the channel information transmission method for transmitting channel information for one constructed downlink component carrier through the PUSCH of one uplink component carrier according to another embodiment of the present invention.

At this time, the downlink component carrier, which should be reported, may be configured by the downlink component carrier linked with the uplink grant. For example, when a CIF value of the uplink grant included in the downlink PCC 610 is “0”, the uplink grant indicates the uplink PCC as shown in FIG. 6. At this time, the downlink component carrier linked with the uplink PCC 620 indicated by the CIF value “0” is the downlink PCC 610 so that channel information of the downlink PCC 610 may be reported to the PUSCH of the uplink PCC 620.

Accordingly, the uplink component carrier, in which the PUSCH is included, reported by the uplink grant including the CQI triggering bit 420 is determined, and channel information such as the CQI/PMI/RI of the downlink component carrier linked with the uplink component carrier may be reported through the PUSCH of the uplink component carrier.

In general, there is no uplink component carrier which does not have the linkage relation since the number of downlink component carriers is larger than or the same as the number of uplink component carriers. As described above, the CQI/PMI/RI for the downlink component carrier which does not have the linkage relation may be reported by using the control information of the downlink component carrier, such as the control information of the downlink PCC 610, with the remaining code point of the CIF 410 or the combination of the remaining code point and the CQI triggering bit

By using some of the remaining code points of the CIF 410 or the combination of the remaining code points of the CIF 410 and the CQI triggering bit 420, the downlink component carriers, which are not linked with the uplinks, are indicated as described above, and the uplink component carrier, to which the PUSCH for the reporting is transmitted, is determined by the higher layer signaling or a determined rule (for example, uplink PCC 650) and then transmitted.

As described above, the reserved code point and the used code point may be discriminated from each other based on the maximum number of carriers. Further, as described below, the reserved code point and the used code point may be semi-statically determined by an RRC configuration or the maximum number of carriers available for a specific user equipment, or may be determined by activation/deactivation through an MAC signaling.

Meanwhile, the downlink component carrier and the uplink component carrier may have the linkage relation therebetween. The linkage relation may be established by the RRC signaling. The linkage relation may be notified to the user equipment through a predetermined rule or may be implicitly notified by using separate control information.

As shown in FIG. 6, the downlink component carriers 612 to 614, which are not linked with the uplink grant, are indicated by using the remaining code points of the CIF 410 on an assumption that there are 5 downlink component carriers 610 to 614 and two uplink component carriers 620 and 621.

At this time, since there are two uplink component carriers 620 and 621, values 0 to 1 indicate the uplink component carriers 620 and 621 and values 2 to 7 may be the reserved code points in the 3-bit CIF 410. When the uplink component carriers 620 and 621 of the CIF having values 0 to 1 have the linkage relation with the downlink component carriers 610 and 611 of the CIF having values 0 to 1, there is no uplink component carriers linked with the downlink component carriers 612 to 614 of the CIF having values 2 to 7. In this case, if values 2 to 7 are allocated to the CIF in the uplink grant and the CQI triggering bit 420 is set, it means that the channel information reporting such as the CQI/PMI/RI reporting for the downlink component carriers 612 to 614 having no linkage relation with the uplink grant is requested.

That is, when the CIF has values 2 to 7 in the uplink grant, the downlink component carriers having values 2 to 7, which have no linkage relation, may be indicated by the downlink component carriers to which the channel information such as the CQI/PMI/RI should be reported. In the above description, an example where the CIF values in the uplink grant and the CIF values identifying the downlink component carrier are the same is discussed, but another example where the CIF values in the uplink grant and the CIF values identifying the downlink component carrier are not the same is possible.

At this time, the base station can inform the user equipment of the downlink component carrier, which has no linkage relation, indicated by the CIF values in the uplink grant through the downlink component carrier, to which the channel information such as the CQI/PMI/RI should be reported, through a higher layer signaling, a predetermined rule, or separate control information.

Meanwhile, as shown in FIG. 7, when there are five downlink component carriers 710 to 714 and five uplink component carriers 720 to 724, code points 0 to 4 of the CIF are used to indicate the uplink component carriers 720 to 724. When the reserved code points have values of 5 to 7, the reserved code points cannot indicate all the downlink component carriers 711 to 714, since the maximum number of downlink component carriers 711 to 714, which are not linked with the uplink grant, is four.

At this time, by using some combinations of the remaining code points of the CIF and the CQI triggering bit 420, all the downlink component carriers, which are not linked with the uplink grant, can be indicated. For example, even for a case where the CQI triggering bit 420 is “0”, the downlink component carriers 711 to 714, which are not linked with the uplink grant, can be indicated by using the reserved code points of the CIF 410 and the combinations. That is, when the CQI triggering bit 420 is “0” and the reserved code point has a specific value, it is considered as a triggering case and it may be used to indicate the downlink component carriers having no linkage relation as shown in Table 6.

TABLE 6

| CQI request | CIR | Information |
|---|---|---|
| 1 | 5 | First component carrier triggering having no |
| | | linkage relation of the downlink carrier |
| 1 | 6 | Second component carrier triggering having |
| | | no linkage relation of the downlink carrier |
| 1 | 7 | Third component carrier triggering having no |
| | | linkage relation of the downlink carrier |
| 0 | 5 | Fourth component carrier triggering having no |
| | | linkage relation of the downlink carrier |

In this case, the channel information reporting such as the CQI/PMI/RI reporting can be performed through a specific uplink component carrier by the higher layer signaling, for example, the PUSCH of the uplink component carrier corresponding to the CIF 1, or through the PUSCH of the uplink component carrier corresponding to a predetermined rule (for example, PCC, CIF 0).

So far, the channel information transmission method for transmitting the channel information for configured one downlink component carrier through the PUSCH of one uplink component carrier according to another embodiment of the present invention has been described. Hereinafter, a channel information transmission method for transmitting the channel information for configured two or more downlink component carriers through the PUSCH of one uplink component carrier according to another embodiment of the present invention will be described.

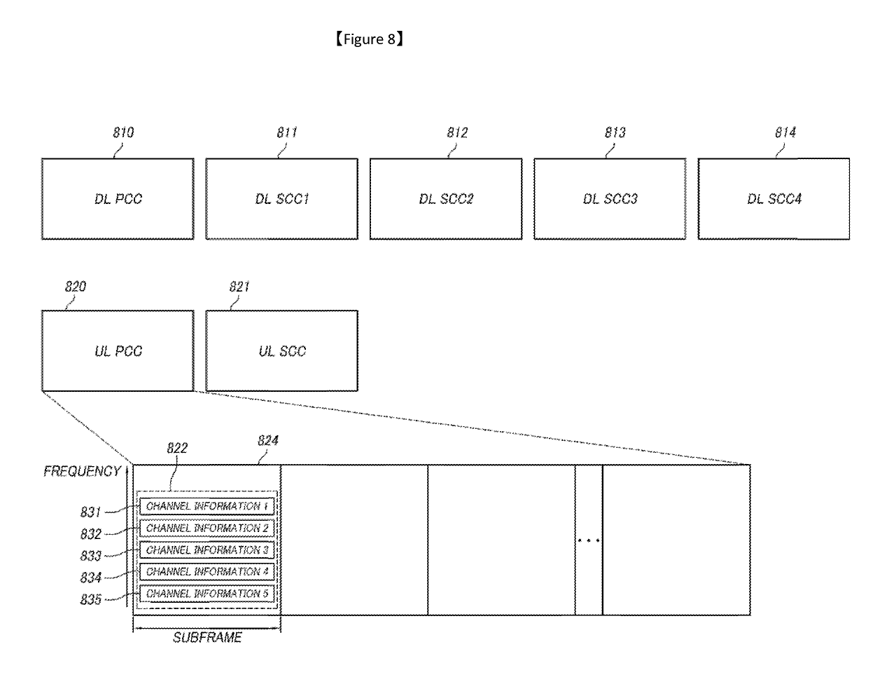

FIG. 8 illustrates a concept of the channel information transmission method for transmitting the channel information for all of configured two or more downlink component carriers through the PUSCH of one uplink component carrier according to another embodiment of the present invention.

As shown in FIG. 8, there may be five downlink component carriers 810 to 814 and two uplink component carriers 820 and 821. As shown in FIG. 8, when two or more component carriers are configured, the channel information reporting, such as the CQI/PMI reporting for a plurality of component carriers instead of each component carrier, may be transmitted through one PUSCH 822 of one uplink component carrier 820.

That is, the aperiodic channel information 831 to 835 is constructed for each of the configured downlink component carriers 810 to 814, and all the channel information 831 to 835 may be transmitted on one PUSCH 822 in one subframe 824 in series.

A transmission mode of the channel information reporting such as the CQI/PMI/RI of each component carrier may be determined by the higher layer signaling. That is, the one PUSCH 822 in one subframe 824 is punctured for an Uplink Shared Channel (UL-SCH) and the aperiodic channel information may be reported through the remaining regions or portions.

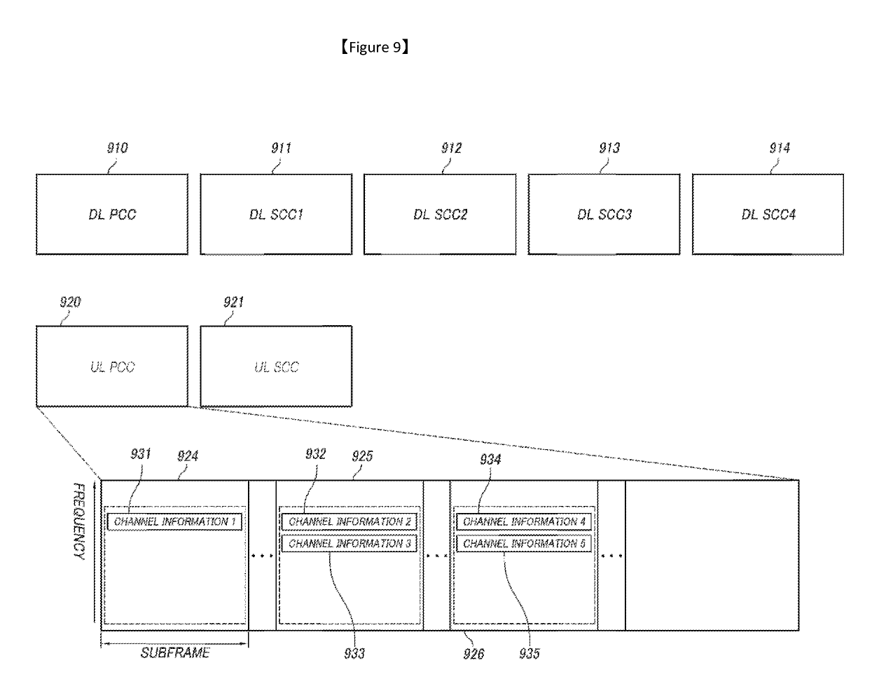

FIG. 9 illustrates a concept of the channel information transmission method for transmitting the channel information for a part of two or more constructed downlink component carriers through the PUSCH of one uplink component carrier according to another embodiment of the present invention.

As shown in FIG. 9, there may be five downlink component carriers 910 to 914 and two uplink component carriers 920 and 921. As shown in FIG. 9, when two or more component carriers are configured, channel information for a part of the two or more component carriers may be transmitted through the PUSCH of multiple subframes of one uplink component carrier.

For example, when the UCI information including the channel information of five downlink component carriers 910 to 914 which are the DL PCC, the SCC#1, the SCC#2, the SCC#3, the SCC#4 is transmitted, channel information 931 for the DL PCC 910 may be transmitted through the PUSCH of a first subframe 924 of the UL PCC 920 in a first aperiodic reporting and channel information 932 and 933 for the SCC#1 911 and the SCC#2 912 may be transmitted through the PUSCH of a second subframe 925 of the UL PCC 920 in a second aperiodic reporting. At this time, unspecific subframes may be included among the first subframe 924, the second subframe 925, and a third subframe 926.

In this event, the period indicating the number of subframes of the uplink component carrier, on which the channel information is divided for transmission, the number of channel information elements of the downlink component carrier transmitted in each subframe, and the channel information reporting transmission mode may change. At this time, they are notified to the user equipment 320 by the higher layer signaling or by using the reserved code points of the CIF 410 included in the control information (uplink grant) or the combinations of the reserved code points of the CIF 410 and the CQI triggering bit 420.

As a first example, one of the reserved code points may be used as the triggering for the channel information reporting of multiple downlink component carriers. In this case, the component carrier including the PUSCH through which the channel information is transmitted is assumed by a regular rule or predetermined by the higher layer signaling. The component carrier assumed by the regular rule may be the PCC. However, the component carrier of the present invention is not limited thereto and may be a specific SCC. Meanwhile, the used reserved code points of the CIF 410 and the reporting mode of the component carrier are determined by the higher layer signaling.

As a second example, the downlink component carriers, which will be reported to each of the reserved code points of the CIF 410 together with the channel information reporting triggering, may be indicated as shown in Table 7 by using a plurality of reserved code points of the CIF 410.

TABLE 7

| CIF | Information |
|---|---|
| 5 | Transmit the UCI for the PCC and the SCC#1 |
| 6 | Transmit the UCI for the SCC#2 and the SCC#3 |
| 7 | Transmit the UCI for the PCC, the SCC#1, the SCC#2, and SCC#3 |

In the event, the component carrier including the PUSCH through which the channel information is transmitted is assumed by the regular rule or predetermined by the higher layer signaling as well. The component carriers corresponding to the reserved code points and the combinations may be determined by the higher layer signaling. A reporting mode of each component carrier may be determined by the higher layer signaling.

When the aperiodic CQI triggering bit 420 is “0”, more component carriers to be reported may be indicated by using the code points of the CIF 410 as defined in Table 8.

TABLE 8

| QI request | CIF | Information |
|---|---|---|
| 1 | 5 | Transmit the UCI for the PCC and the SCC#1 |
| 1 | 6 | Transmit the UCI for the SCC#2 and the SCC#3 |
| 1 | 7 | Transmit the UCI for the PCC, the SCC#1, and the |
| | | SCC#2 |
| 0 | 5 | Transmit the UCI for the SCC#1, the SCC#2, and |
| | | SCC#3 |
| 0 | 6 | Transmit the UCI for the PCC, the SCC#2, and SCC#3 |
| 0 | 7 | Transmit the UCI for the PCC, the SCC#1, the SCC#2, |
| | | and SCC#3 |

At this time, when more downlink component carriers to be reported are indicated by using the code points of the CIF 410 in a case where the aperiodic CQI triggering bit 420 is “0”, the combinations of the CQI triggering bit 420 and the reserved code points of the CIF 410 may be changed.

Referring to FIG. 3 again, the control information transmitter 312 of the base station 310 transmits the control information 330 including a channel information request such as the aperiodic CQI trigger bit 420 and carrier identification information designating the downlink component carrier, which will report the channel information such as the CIF 410, to the user equipment 320 through one of the downlink component carriers as shown in the first and second examples. As a result, the channel information receiver 314 receives the channel information 330 for the downlink component carrier designated by the carrier identification information such as the CIF 410 from the user equipment through one of the aperiodic uplink component carriers.

The control information receiver 322 of the user equipment 320 receives the control information 330 including the channel information request such as the aperiodic CQI triggering bit 420 and the carrier identification information designating the downlink component carrier, which will report the channel information such as the CIF 410, from the base station 310 through one of the downlink component carriers. As a result, the channel information transmitter 324 transmits the channel information for the downlink component carrier designated by the carrier identification information such as the CIF 410 to the base station 310 through one of the uplink component carriers.

As described through the second example, when the channel information request such as the aperiodic CQI triggering bit 420 is “0” and “1”, the designated downlink component carrier may be different although the carrier identification information such as the CIF 410 is the same code point. In other words, the downlink component carrier, which will report the channel information, may be designated through the combinations of the aperiodic CQI triggering bit and the reserved code point.

As a third example, the uplink component carrier, in which the channel information is carried on each of the reserved code points together with the triggering of the channel information reporting, may be indicated as shown in Table 9 by using a plurality of reserved code points, but it is not limited thereto. In this case, a period of the downlink component carrier, to which the channel information is reported, and the component carriers, which will be transmitted in each channel information reporting section, may be determined by the higher layer signaling.

TABLE 9

| CIF | Information |
|---|---|
| 5 | The channel information is transmitted through the PUSCH |
| | included in the PCC |
| 6 | The channel information is transmitted through the first SCC |
| | designated by the base station (higher layer signaling) |
| 7 | The channel information is transmitted through the second SCC |
| | designated by the base station (higher layer signaling) |

As a fourth example, the uplink component carrier, in which the channel information is carried on each of the reserved code points together with the triggering of the channel information reporting, may be indicated as shown in Table 10 by using a plurality of reserved code points, but it is not limited thereto.

TABLE 10

| CQI request | CIF | Information |
|---|---|---|
| 1 | 5 | The channel information is transmitted through |
| | | the PUSCH included in the uplink PCC |
| 1 | 6 | The channel information is transmitted through the |
| | | PUSCH included in the first SCC designated by the |
| | | base station (higher layer signaling) |
| 1 | 7 | The channel information is transmitted through the |
| | | PUSCH included in the second SCC designated by |
| | | the base station (higher layer signaling) |
| 0 | 5 | The channel information is transmitted through the |
| | | PUSCH included in the third SCC designated by the |
| | | base station (higher layer signaling) |
| 0 | 6 | The channel information is transmitted through the |
| | | PUSCH included in the fourth SCC designated by |
| | | the base station (higher layer signaling) |

In the fourth example, the combinations of the aperiodic CQI triggering bit 420 and the reserved code point of the CIF 410 may be changed.

Referring to FIG. 3 again, the control information transmitter 312 of the base station 310 transmits the control information 330 including a channel information request such as the aperiodic CQI trigger bit 420 and carrier identification information designating the uplink component carrier, which reports the channel information for one of the downlink component carriers such as the CIF 410, to the user equipment 320 through one of the downlink component carriers as shown in the third and fourth examples. As a result, the channel information receiver 314 receives the channel information 330 for one of the downlink component carriers from the user equipment 320 through the aperiodic uplink component carrier designated by the carrier identification information.

The control information receiver 322 of the user equipment 320 receives the control information 330 including the channel information request such as the aperiodic CQI triggering bit 420 and the carrier identification information designating the downlink component carrier, which reports the channel information for one of the downlink component carriers such as the CIF 410, from the base station 310 through one of the downlink component carriers. As a result, the channel information transmitter 324 transmits the channel information 340 for one of the downlink component carriers to the base station 310 through the uplink component carriers designated by the carrier identification information.

As the last example, the combinations of the reserved code point of the CIF 410 and the aperiodic CQI triggering bit 420 may be used to select a mode for the channel information reporting of multiple downlink component carriers.

In the carrier aggregation using one or more component carriers, a UCI reporting mode of multiple downlink component carriers or a channel information reporting mode for a Multiple Input Multiple Output (MIMO) other than the currently existing reporting mode (single component carrier reporting mode) may be newly defined. When the various reporting modes exist and the modes are configured to be dynamically converted, only the reserved code points of the CIF 410 are used as shown in Table 11 or the combinations of the reserved code points and the aperiodic CQI triggering bit 420 are used as shown in Table 12, to transmit the channel information mode.

TABLE 11

| CQI request | CIF | Information |
|---|---|---|
| 1 | 5 | UCI reporting mode 1 of the multiple component |
| | | carriers |
| 1 | 6 | UCI reporting mode 2 of the multiple component |
| | | carriers |
| 1 | 7 | UCI reporting mode 3 of the multiple component |
| | | carriers |

TABLE 12

| CQI request | CIF | Information |
|---|---|---|
| 1 | 5 | UCI reporting mode 1 of the multiple component |
| | | carriers |
| 1 | 6 | UCI reporting mode 2 of the multiple component |
| | | carriers |
| 1 | 7 | UCI reporting mode 3 of the multiple component |
| | | carriers |
| 0 | 5 | UCI reporting mode 4 of the multiple component |
| | | carriers |
| 0 | 6 | UCI reporting mode 5 of the multiple component |
| | | carriers |
| 0 | 7 | UCI reporting mode 2 of the multiple component |
| | | carriers |

Referring to FIG. 3 again, in the carrier aggregation wireless communication system using one or more downlink component carriers or one or more uplink component carriers, the base station 310 includes the control information transmitter 312 transmitting the control information 330 including the channel information request and the carrier identification information designating the channel information transmission mode of the downlink component carrier to the user equipment 320 through one of the downlink component carriers, and the channel information receiver 314 aperiodically receiving the channel information 340 of the downlink component carrier from the user equipment 320 through one of the uplink component carriers in the channel information transmission mode of the downlink component carrier designated by the carrier identification information, as shown in the last two examples.

Meanwhile, in the carrier aggregation wireless communication system using one or more downlink component carriers or one or more uplink component carriers, the user equipment 320 may include the control information receiver 322 receiving the control information 330 including the channel information request and the carrier identification information designating the channel information transmission mode of the downlink component carrier from the base station through one of the downlink component carriers, and the channel information transmitter 324 aperiodically transmitting the channel information 340 of the downlink component carrier to the base station 310 through one of the uplink component carriers in channel information transmission mode of the downlink component carrier designated by the carrier identification information.

Through the aforementioned embodiments, it is possible to reach a compromise among a PUSCH performance, an overhead, and a channel information reporting delay, and obtain various operations of the channel information. Further, through the aforementioned embodiments, the control information related to the channel information may be transmitted to the user equipment from the base station even though additional resources of the control signal are not allocated.

While the exemplary embodiments have been shown and described, it will be understood by those skilled in the art that various changes in form and details may be made thereto without departing from the spirit and scope of this disclosure as defined by the appended claims and their equivalents. Thus, as long as modifications fall within the scope of the appended claims and their equivalents, they should not be misconstrued as a departure from the scope of the invention itself.

1. A method of receiving channel information by a base station in a carrier aggregation wireless communication system using one or more downlink component carriers and one or more uplink component carriers, the method comprising:
transmitting control information including an aperiodic channel information request and carrier identification information designating an uplink component carrier reporting the channel information to a user equipment through one of downlink component carriers; and
receiving channel information for a downlink component carrier that is linked to the uplink component carrier designated by the carrier identification information from the user equipment through the designated uplink component carrier.

2. The method as claimed in claim 1, further comprising transmitting a linkage relation between the uplink component carrier and the downlink component carrier through an RRC (Radio Resource Control) signaling.

3. The method as claimed in claim 1, wherein the downlink component carrier transmitting the control information and the uplink component carrier designated by the carrier identification information have no linkage relation between them.

4. A method of receiving channel information by a base station in a carrier aggregation wireless communication system using one or more downlink component carriers and one or more uplink component carriers, the method comprising:
transmitting information for a downlink component carrier to a user equipment through a Radio Resource Control (RRC) signaling, wherein channel information for the downlink component carrier is transmitted through an uplink component carrier;
transmitting control information including an aperiodic channel information request and carrier identification information designating an uplink component carrier reporting the channel information to the user equipment through one of downlink component carriers; and
receiving channel information for a downlink component carrier configured through the RRC signaling from the user equipment through the uplink component carrier.

5. The method as claimed in claim 4, wherein, when there are multiple downlink component carriers, the channel information for the downlink component carriers is transmitted in series.

6. The method as claimed in claim 4, wherein the downlink component carrier transmitting the control information and the uplink component carrier designated by the carrier identification information have no linkage relation between them.

7. A method of receiving channel information by a base station in a carrier aggregation wireless communication system using one or more downlink component carriers and one or more uplink component carriers, the method comprising:
transmitting control information including an aperiodic channel information request and carrier identification information designating an uplink component carrier reporting the channel information to a user equipment through one of downlink component carriers; and
receiving channel information for a plurality of downlink component carriers transmitted in series from the user equipment through the uplink component carrier.

8. The method as claimed in claim 7, wherein the control information includes information for selecting the plurality of downlink component carriers.

9. The method as claimed in claim 7, further comprising transmitting information for setting the plurality of downlink component carriers through a Radio Resource Control (RRC) signaling.

10. A base station in a carrier aggregation wireless communication system using one or more downlink component carriers and one or more uplink component carriers, the base station comprising:
a control information transmitter for transmitting control information including an aperiodic channel information request and carrier identification information designating an uplink component carrier reporting the channel information to a user equipment through one of downlink component carriers; and
a channel information receiver for receiving channel information for a downlink component carrier that is linked to the uplink component carrier designated by the carrier identification information from the user equipment through the designated uplink component carrier.

11. The base station claimed in claim 10, wherein a linkage relation between the uplink component carrier and the downlink component carrier is transmitted through a Radio Resource Control (RRC) signaling.

12. The base station claimed in claim 10, wherein the downlink component carrier transmitting the control information and the uplink component carrier designated by the carrier identification information have no linkage relation between them.

13. A base station in a carrier aggregation wireless communication system using one or more downlink component carriers and one or more uplink component carriers, the base station comprising:
a control information transmitter for transmitting control information including an aperiodic channel information request and carrier identification information designating an uplink component carrier reporting the channel information to a user equipment through one of downlink component carriers; and
a channel information receiver for receiving channel information for downlink component carriers configured through a Radio Resource Control (RRC) signaling transmitted to the user equipment from the user equipment through the uplink component carrier.

14. The base station claimed in claim 13, wherein, when there are multiple downlink component carriers, the channel information for the downlink component carriers is transmitted in series.

15. The base station claimed in claim 13, wherein the downlink component carrier transmitting the control information and the uplink component carrier designated by the carrier identification information have no linkage relation between them.

16. A base station in a carrier aggregation wireless communication system using one or more downlink component carriers and one or more uplink component carriers, the base station comprising:
a control information transmitter for transmitting control information including an aperiodic channel information request and carrier identification information designating an uplink component carrier reporting the channel information to a user equipment through one of downlink component carriers; and
a channel information receiver for receiving channel information for multiple downlink component carriers transmitted in series from the user equipment through the uplink component carrier.

17. The base station claimed in claim 16, wherein the control information includes information for selecting the multiple downlink component carriers.

18. The base station claimed in claim 16, wherein information for setting the multiple downlink component carriers is transmitted through a Radio Resource Control (RRC) signaling.

19. A method of transmitting channel information by an user equipment in a carrier aggregation wireless communication system using one or more downlink component carriers and one or more uplink component carriers, the method comprising:
receiving control information including an aperiodic channel information request and carrier identification information designating an uplink component carrier reporting the channel information from a base station through one of downlink component carriers; and
transmitting channel information for a downlink component carrier that is linked to the uplink component carrier designated by the carrier identification information to the base station through the designated uplink component carrier.

20. The method claimed in claim 19, further comprising receiving a linkage relation between the uplink component carrier and the downlink component carrier through a Radio Resource Control (RRC) signaling.

21. The method claimed in claim 19, wherein the downlink component carrier transmitting the control information and the uplink component carrier designated by the carrier identification information have no linkage relation between them.

22. A method of transmitting channel information by an user equipment in a carrier aggregation wireless communication system using one or more downlink component carriers and one or more uplink component carriers, the method comprising:
receiving information for a downlink component carrier from a base station through a Radio Resource Control (RRC) signaling, wherein channel information for the downlink component carrier is transmitted through an uplink component carrier;
receiving control information including an aperiodic channel information request and carrier identification information designating an uplink component carrier reporting the channel information from the base station through one of downlink component carriers; and
transmitting channel information for a downlink component carrier configured through the RRC signaling to the base station through the uplink component carrier.

23. The method as claimed in claim 22, wherein, when there are multiple downlink component carriers, the channel information for the downlink component carriers is transmitted in series.

24. The method as claimed in claim 22, wherein the downlink component carrier transmitting the control information and the uplink component carrier designated by the carrier identification information have no linkage relation between them.

25. A method of transmitting channel information by an user equipment in a carrier aggregation wireless communication system using one or more downlink component carriers and one or more uplink component carriers, the method comprising:
receiving control information including an aperiodic channel information request and carrier identification information designating an uplink component carrier reporting the channel information from a base station through one of downlink component carriers; and
transmitting channel information for a plurality of downlink component carriers in series to the base station through the uplink component carrier.

26. The method as claimed in claim 25, wherein the control information includes information for selecting the multiple downlink component carriers.

27. The method as claimed in claim 25, further comprising receiving information for setting the multiple downlink component carriers through a Radio Resource Control (RRC) signaling.

28. An user equipment in a carrier aggregation wireless communication system using one or more downlink component carriers and one or more uplink component carriers, the user equipment comprising:
a control information receiver for receiving control information including an aperiodic channel information request and carrier identification information designating an uplink component carrier reporting the channel information from a base station through one of downlink component carriers; and
a channel information transmitter for transmitting channel information for a downlink component carrier that is linked to the uplink component carrier designated by the carrier identification information to the base station through the designated uplink component carrier.

29. The user equipment as claimed in claim 28, wherein the linkage relation between the uplink component carrier and the downlink component carrier is transmitted through a Radio Resource Control (RRC) signaling.

30. The user equipment as claimed in claim 28, wherein the downlink component carrier transmitting the control information and the uplink component carrier designated by the carrier identification information have no linkage relation between them.

31. An user equipment in a carrier aggregation wireless communication system using one or more downlink component carriers and one or more uplink component carriers, the user equipment comprising:
a control information receiver for receiving control information including an aperiodic channel information request and carrier identification information designating an uplink component carrier reporting the channel information from a base station through one of downlink component carriers; and
a channel information transmitter for transmitting channel information for a downlink component carrier configured through a Radio Resource Control (RRC) signaling transmitted from the base station to the base station through the uplink component carrier.

32. The user equipment claimed in claim 31, wherein, when there are multiple downlink component carriers, the channel information for the downlink component carriers is transmitted in series.

33. The user equipment claimed in claim 31, wherein the downlink component carrier transmitting the control information and the uplink component carrier designated by the carrier identification information have no linkage relation between them.

34. An user equipment in a carrier aggregation wireless communication system using one or more downlink component carriers and one or more uplink component carriers, the user equipment comprising:
a control information receiver for receiving information including an aperiodic channel information request and carrier identification information designating an uplink component carrier reporting channel information from a base station through one of downlink component carriers;
a channel information transmitter for transmitting channel information for multiple downlink component carriers in series to the base station through the uplink component carrier.

35. The user equipment as claimed in claim 34, wherein the control information includes information for selecting the multiple downlink component carriers.

36. The user equipment as claimed in claim 34, wherein information for setting the multiple downlink component carriers is received through a Radio Resource Control (RRC) signaling.
